(19) United States
(12) Patent Application Publication
(10) Pub. No.: US 2025/0035851 A1
(43) Pub. Date: Jan. 30, 2025

(54) OPTICAL DEVICE, OPTICAL TRANSMISSION APPARATUS, AND OPTICAL RECEPTION APPARATUS

(71) Applicant: FUJITSU OPTICAL COMPONENTS LIMITED, Kawasaki-shi (JP)

(72) Inventors: Yurika YANADA, Kawasaki (JP); Nobuaki MITAMURA, Saitama (JP)

(73) Assignee: FUJITSU OPTICAL COMPONENTS LIMITED, Kawasaki-shi (JP)

(21) Appl. No.: 18/746,486

(22) Filed: Jun. 18, 2024

(30) Foreign Application Priority Data
Jul. 27, 2023 (JP) 2023-122262

(51) Int. Cl. G02B 6/30

(52) U.S. Cl. CPC G02B 6/30

(57) ABSTRACT

An optical device includes an optical element and an optical fiber block. The optical element includes an optical waveguide, a first end face on which an end face of the optical waveguide is disposed, and a second end face protruding from the first end face. The optical fiber block includes an optical fiber, a third end face on which an end face of the optical fiber is disposed, and a fourth end face recessed from the third end face. In the optical device, in a state where the second end face and the fourth end face are fixed so as to be in contact with each other, the first end face and the third end face are connected by butt coupling to optically couple the end face of the optical waveguide and the end face of the optical fiber.

### CROSS-REFERENCE TO RELATED APPLICATION

This application is based upon and claims the benefit of priority of the prior Japanese Patent Application No. 2023-122262, filed on Jul. 27, 2023, the entire contents of which are incorporated herein by reference.

### FIELD

The embodiments discussed herein are related to an optical device, an optical transmission apparatus, and an optical reception apparatus.

### BACKGROUND

In recent years, in an optical device including an optical waveguide, it is needed to increase a transmission capacity of optical data. In addition, in an optical transceiver having an optical transmission/reception function, an optical waveguide suitable for miniaturization and integration is widely adopted.

FIG. 19 is a schematic cross-sectional view illustrating an example of an optical device 100 in the related art. The optical device 100 illustrated in FIG. 19 includes an optical element 110 and an optical fiber block 120. The optical element 110 is an optical element formed based on a silicon on insulator (SOI) wafer. The optical element 110 includes a Si substrate 111, an insulating layer 112, an optical waveguide 113, and a passivation layer 114. The Si substrate 111 is a support substrate constituting an SOI wafer. The insulating layer 112 is formed of SiO₂ stacked on the Si substrate 111, and functions as a lower cladding layer of the optical waveguide 113. The optical waveguide 113 is a Si optical waveguide formed on the insulating layer 112. The passivation layer 114 is formed of, for example, SiO₂, Si₃N₄, or the like, and functions as an upper cladding layer of the optical waveguide 113.

The optical fiber block 120 includes an optical fiber 121 and a glass block 122. The optical fiber 121 includes a core 121B and a cladding 121A covering the core 121B. While the optical fiber 121 is inserted into the glass block 122, the optical fiber 121 and the glass block 122 are fixed with an optical adhesive A.

An end face 113A of the optical waveguide 113 and a core end face 121B1 of the optical fiber 121 are optical surfaces (mirror surfaces) in order to prevent light scattering. Then, the end face 113A of the optical waveguide 113 and the core end face 121B1 are optically coupled by a butt-joint using an optical adhesive A that is transparent in the optical communication wavelength range. At this time, in order to sufficiently reduce the optical coupling loss between the optical waveguide 113 and the core 121B of the optical fiber 121, the optical axis of the end face 113A of the optical waveguide 113 and the optical axis of the core end face 121B1 of the optical fiber 121 are adjusted to substantially the same position in the vertical and horizontal directions. Furthermore, the distance between the end face 113A of the optical waveguide 113 and the core end face 121B1 of the optical fiber 121 is also sufficiently shortened.

FIG. 20 is a schematic cross-sectional view illustrating an example of a cutting step of the optical element 110 in the related art. As illustrated in FIG. 20, the optical element 110 is vertically diced using a rotating cutting blade B1. FIG. 21 is a schematic cross-sectional view illustrating an example of the optical element 110 after the cutting step. In the optical element 110 after dicing, as illustrated in FIG. 21, a cut surface 110A including the end face 113A of the optical waveguide 113 is rough, and light scattering increases as it is, so that optical coupling loss between the optical waveguide 113 and the optical fiber 121 increases.

FIG. 22 is a schematic cross-sectional view illustrating an example of the optical element 110 in a polishing step. In the optical element 110 after dicing, as illustrated in FIG. 22, the end face 113A of the optical waveguide 113 is optically polished using a polishing machine B2 in a state where the cut surface 110A faces downward, so that the end face 113A becomes an optical surface. In addition, the core end face 121B1 of the optical fiber 121 similarly needs to be processed by optical polishing. Therefore, since the optical element 110 undergoes processing steps of cutting (dicing) and optical polishing, the processing cost increases and the lead time increases.

Therefore, in recent years, a method for lapping using a special blade B3 with abrasive grains attached to the blade side surface has been developed, and the lead time can be shortened by continuously executing the cutting step and the end face polishing step with one blade dicing device. FIG. 23 is a schematic cross-sectional view illustrating an example of a lapping step of the optical element 110. For example, after the dicing of the optical element 110 is performed using the blade B3, the blade is continuously inserted into a cut groove 110C in the optical element 110 cut by the blade B3, and the end face 113A of the optical waveguide 113 above the optical element 110 is polished by the blade B3 to form an end face 110B on the cut surface 110A. As a result, the end face 110B including the end face 113A of the optical waveguide 113 of the optical element 110 becomes the optical surface.
Patent Literature 1: Japanese Laid-open Patent Publication No. 2020-106678
Patent Literature 2: Japanese Laid-open Patent Publication No. 2003-057467
Patent Literature 3: Japanese Laid-open Patent Publication No. 2007-199254
Patent Literature 4: U.S. Patent Application Publication No. 2002/0154866
Patent Literature 5: Japanese Laid-open Patent Publication No. 09-026529

However, even if the entire cut surface 110A of the optical element 110 is polished by lapping, the lapping blade B3 applied to the cut surface 110A is warped by the repulsive force from the end face of the optical element 110. As a result, the distance between the end face 113A of the optical waveguide 113 on the cut surface 110A of the optical element 110 and the core end face 121B1 of the optical fiber 121 is not possible to be shortened. Therefore, it is difficult to suppress optical coupling loss between the optical waveguide 113 and the optical fiber 121.

### SUMMARY

According to an aspect of an embodiment, an optical device includes an optical element and an optical fiber block. The optical element includes an optical waveguide, a first end face on which an end face of the optical waveguide is disposed, and a second end face protruding from the first end face. The optical fiber block includes an optical fiber, a third end face on which an end face of the optical fiber is disposed, and a fourth end face recessed from the third end face. The first end face and the third end face are connected by butt coupling to optically couple the end face of the optical waveguide and the end face of the optical fiber in a state where the second end face and the fourth end face are fixed to be in contact with each other.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic cross-sectional view illustrating an example of an optical device according to a first example;

FIG. 2 is a schematic cross-sectional view illustrating an example of a lapping step of an optical fiber block;

FIG. 3 is an explanatory view of the lapping step of the optical fiber block as viewed from a Y direction;

FIG. 4A is a schematic cross-sectional view illustrating an example of the optical fiber block after the lapping step;

FIG. 4B is a schematic cross-sectional view illustrating an example of an optical element after the lapping step;

FIG. 5 is a schematic cross-sectional view illustrating an example of an optical device of a second example;

FIG. 6 is a schematic cross-sectional view illustrating an example of a first lapping step of the optical fiber block;

FIG. 7 is an explanatory view of the first lapping step of the optical fiber block as viewed from the Y direction;

FIG. 8 is a schematic cross-sectional view illustrating an example of a second lapping step of the optical fiber block;

FIG. 9 is an explanatory view of the second lapping step of the optical fiber block as viewed from the Y direction;

FIG. 10 is a schematic cross-sectional view illustrating an example of an optical device of a third example;

FIG. 11 is a schematic cross-sectional view illustrating an example of the lapping step of the optical fiber block;

FIG. 12 is a schematic cross-sectional view illustrating an example of a second glass block disposing step;

FIG. 13 is a schematic cross-sectional view illustrating an example of the optical fiber block;

FIG. 14 is an explanatory view of the optical fiber block as viewed from the Y direction;

FIG. 15 is an explanatory view illustrating an example of an optical transceiver employing the optical device of the present example;

FIG. 16 is a schematic cross-sectional view illustrating an example of an optical device of a first comparative example;

FIG. 17 is a schematic cross-sectional view illustrating an example of an optical element of the first comparative example;

FIG. 18 is a schematic cross-sectional view illustrating an example of an optical device of a second comparative example;

FIG. 19 is a schematic cross-sectional view illustrating an example of an optical device in the related art;

FIG. 20 is a schematic cross-sectional view illustrating an example of a cutting step of the optical element in the related art;

FIG. 21 is a schematic cross-sectional view illustrating an example of the optical element after the cutting step;

FIG. 22 is a schematic cross-sectional view illustrating an example of the optical element in a polishing step; and

FIG. 23 is a schematic cross-sectional view illustrating an example of the lapping step of the optical element.

### DESCRIPTION OF EMBODIMENTS

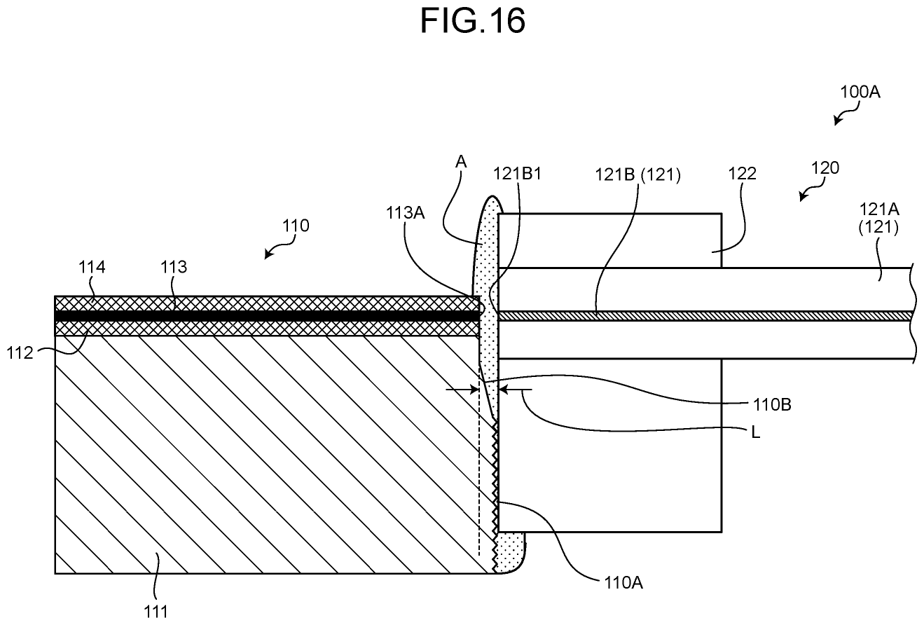

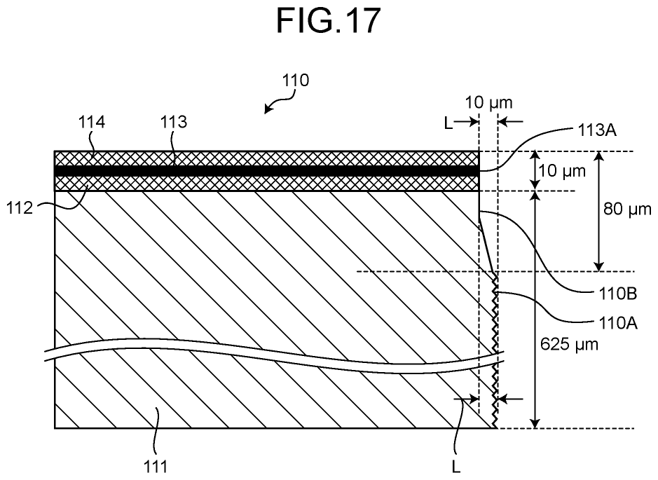

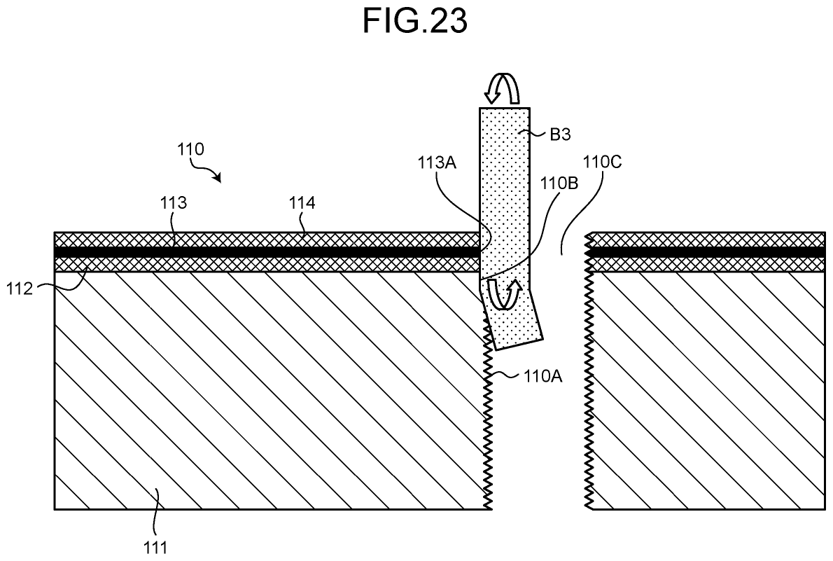

However, as illustrated in FIG. 23, a lapping blade B3 applied to a cut surface 110A of an optical element 110 is warped by a repulsive force at the cut surface 110A, so that the cut surface 110A of the optical element 110 is not possible to be entirely polished. Therefore, a method for lapping only the vicinity of an end face 113A of an optical waveguide 113 of the optical element 110 can be considered. FIG. 16 is a schematic cross-sectional view illustrating an example of an optical device 100A of a first comparative example, and FIG. 17 is a schematic cross-sectional view illustrating an example of an optical element 110 of the first comparative example. Note that, for convenience of description, the thickness of a Si substrate 111 is, for example, 625 μm. Therefore, the entire surface of the cut surface 110A of the optical element 110 is not lapped, but lapped to a depth of about 80 μm from the surface of the optical element 110 on the optical waveguide 113 side, and thereby, an end face 110B to a depth of about 10 μm from the surface of the optical element 110 on the optical waveguide 113 side is optically polished. As a result, the end face 110B including the end face 113A of the optical waveguide 113 becomes the optical surface. At this time, a step L between the end face 113A of the optical waveguide 113 of the optical element 110 and the cut surface 110A is, for example, about 10 μm.

As illustrated in FIG. 16, an optical fiber block 120 in which a core end face 121B1 of an optical fiber 121 and an end face of a glass block 122 are flush with each other is connected to the optical element 110 by a butt-joint. That is, in a state where the cut surface 110A of the optical element 110 and the end face of the glass block 122 are in contact with each other, the end face 113A of the optical waveguide 113 and the core end face 121B1 of the optical fiber 121 are connected with an optical adhesive A by the butt-joint. As a result, the distance between the core end face 121B1 of the optical fiber 121 and the end face 113A of the optical waveguide 113 is 10 μm, which is the step L between the end face 113A of the optical waveguide 113 and the cut surface 110A.

However, even when the core end face 121B1 of the normal optical fiber 121 is directly connected to the end face 113A of the lapped optical waveguide 113 by the butt-joint, the distance between the end face 113A of the optical waveguide 113 and the core end face 121B1 is 10 μm or more. As a result, the optical coupling loss between the optical waveguide 113 and the optical fiber 121 is large, for example, about 1.35 dB.

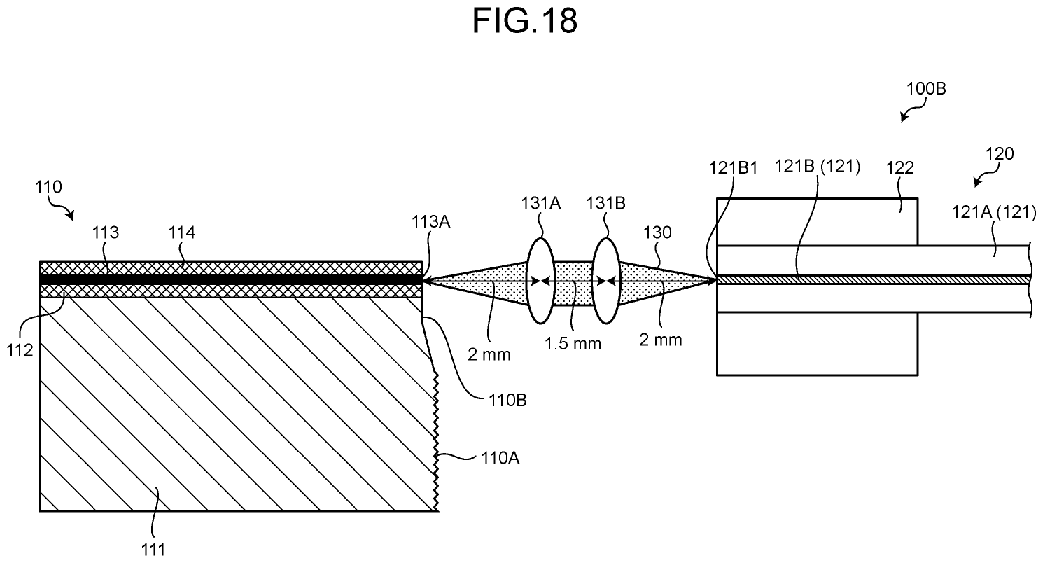

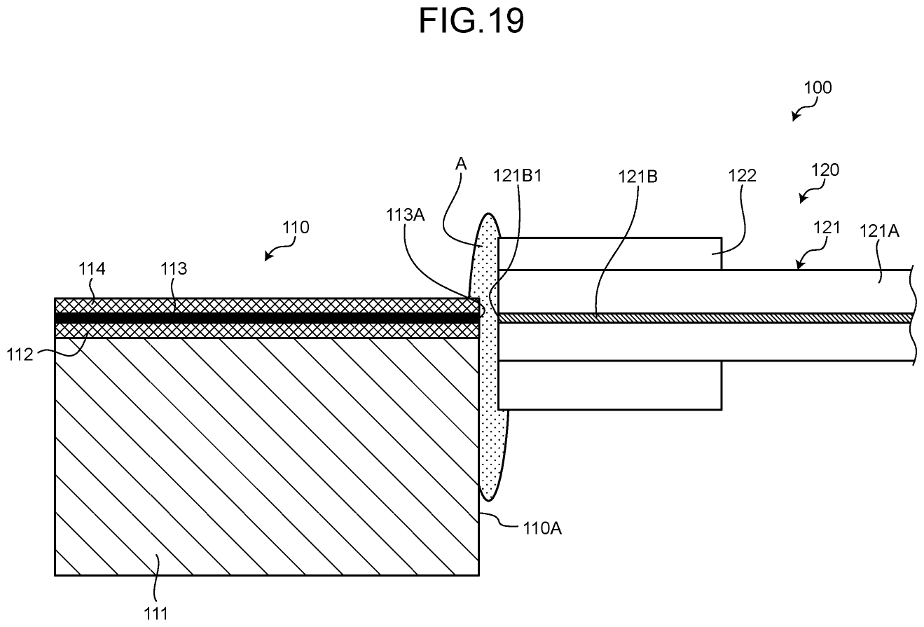

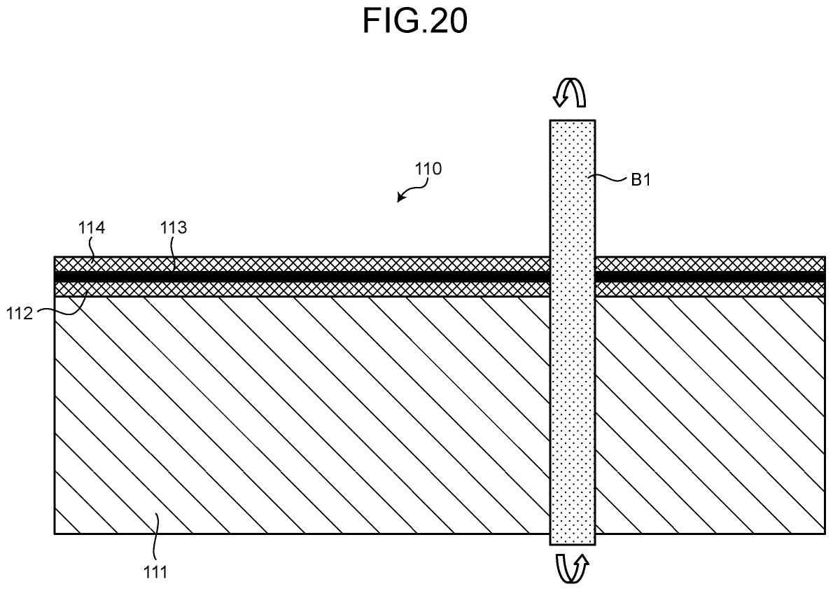

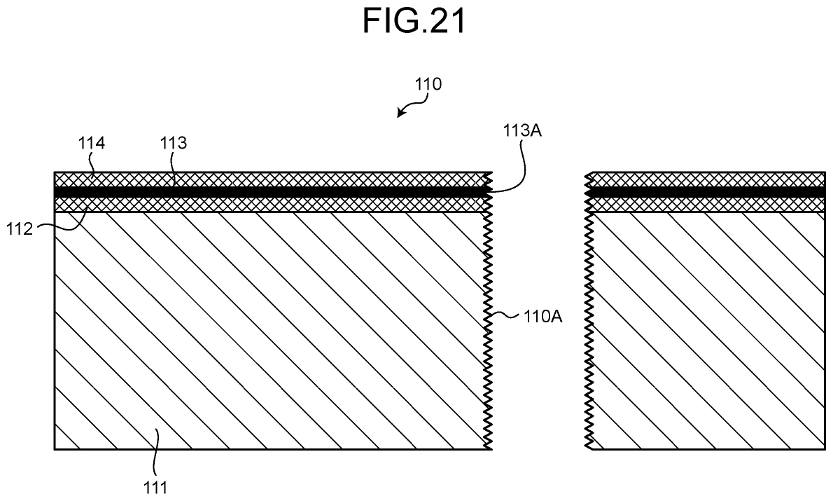

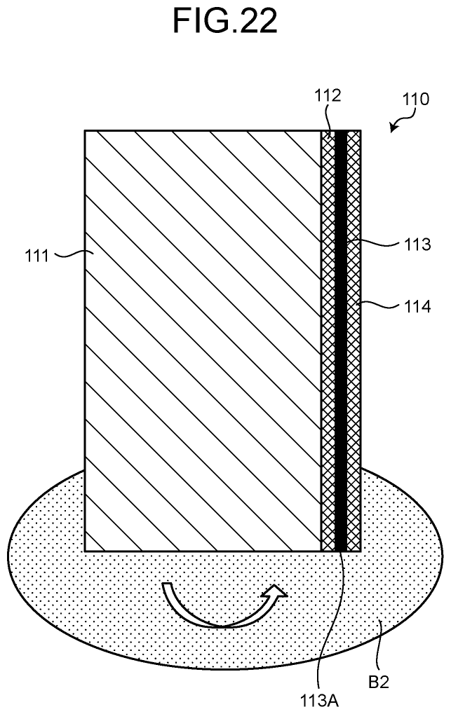

Therefore, in order to suppress the optical coupling loss, a method for providing a lens between the end face 113A of the optical waveguide 113 and the core end face 121B1 of the optical fiber 121 is also considered. FIG. 18 is a schematic cross-sectional view illustrating an example of an optical device 100B of a second comparative example. On an optical path 130 between the end face 113A of the optical waveguide 113 and the core end face 121B1 of the optical fiber 121, a first lens 131A having a focal length of 2 mm and a second lens 131B having a focal length of 2 mm are arranged at an inter-lens distance, for example, 1.5 mm. In the optical device 100B, light emitted from the core end face 121B1 of the optical fiber 121 is condensed by the first lens 131A and the second lens 131B, and is optically coupled to the end face 113A of the optical waveguide 113. However, in the optical device 100B, it is needed to secure a length dimension of 5.5 mm obtained by adding the focal lengths and the inter-lens distance of the first lens 131A and the second lens 131B. As a result, the size of the optical device 100B increases, and the cost for the lens increases.

Therefore, an embodiment of a small optical device capable of suppressing the optical coupling loss between the end face of the optical waveguide of the lapped optical element and the core end face of the optical fiber will be described below as an example. Note that the disclosed technology is not limited by the present example. In addition, the following examples may be appropriately combined as long as there is no contradiction.

### (a) First Example

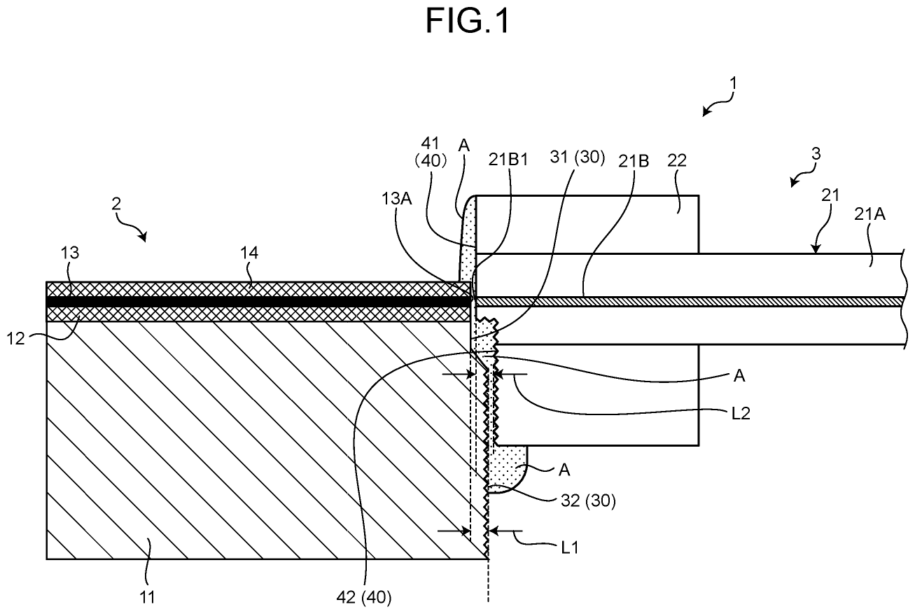

FIG. 1 is a schematic cross-sectional view illustrating an example of an optical device 1 according to a first example. The optical device 1 illustrated in FIG. 1 includes an optical element 2 and an optical fiber block 3. The optical element 2 is an optical element formed based on a silicon on insulator (SOI) wafer. The optical element 2 includes a Si substrate 11, an insulating layer 12, an optical waveguide 13, and a passivation layer 14. The Si substrate 11 is a support substrate constituting the SOI wafer. The insulating layer 12 is formed of SiO₂ stacked on the Si substrate 11, and functions as a lower cladding layer of the optical waveguide 13. The optical waveguide 13 is, for example, a Si optical waveguide formed on the insulating layer 12. The passivation layer 14 is formed of, for example, SiO₂, Si₃N₄, or the like, and functions as an upper cladding layer of the optical waveguide 13.

The optical fiber block 3 includes an optical fiber 21 and a glass block 22. The optical fiber 21 includes a core 21B and a cladding 21A covering the core 21B. While the optical fiber 21 is inserted into the glass block 22, the optical fiber 21 and the glass block 22 are fixed with an optical adhesive A.

The optical element 2 includes an optical waveguide 13, a first end face 31 including an end face 13A of the optical waveguide 13, and a second end face 32 protruding with respect to the first end face 31. The second end face 32 is an end face protruding in the axial direction of the optical waveguide 13. The second end face 32 is formed of a cut surface 30 of the optical element 2 cut by a blade B used for lapping, and the cut surface 30 is a rough surface. Further, the first end face 31 is formed by optically polishing a portion of the cut surface 30 including the end face 13A in the optical polishing step of the blade B. The cut surface 30 of the optical element 2 has a first step L1 between the first end face 31 and the second end face 32.

The optical fiber block 3 includes the optical fiber 21, a third end face 41 including a core end face 21B1 of the optical fiber 21, and a fourth end face 42 recessed from the third end face 41. The third end face 41 of the optical fiber block 3 is constituted by a cut surface 40 of the optical fiber block 3 cut by the blade B used for lapping. The fourth end face 42 is an end face recessed in the axial direction of the core 21B of the optical fiber 21 by being formed in the cutting step of the blade B. The cut surface 40 of the optical fiber block 3 has a second step L2 between the third end face 41 and the fourth end face 42.

The first step L1 of the optical element 2 is substantially equal to the second step L2 of the optical fiber block 3. The dimensions of the first step L1 and the second step L2 are desirably at least 3 μm or less, for example, 1 μm or less in consideration of eliminating the step of 10 μm generated by normal lapping. Then, in the optical device 1, in a state where the second end face 32 and the fourth end face 42 are fixed so as to be in contact with each other, the first end face 31 and the third end face 41 are connected by butt coupling using the optical adhesive A to optically couple the end face 13A of the optical waveguide 13 and the core end face 21B1 of the optical fiber 21.

Next, a method for manufacturing the optical device 1 according to the first example will be described.

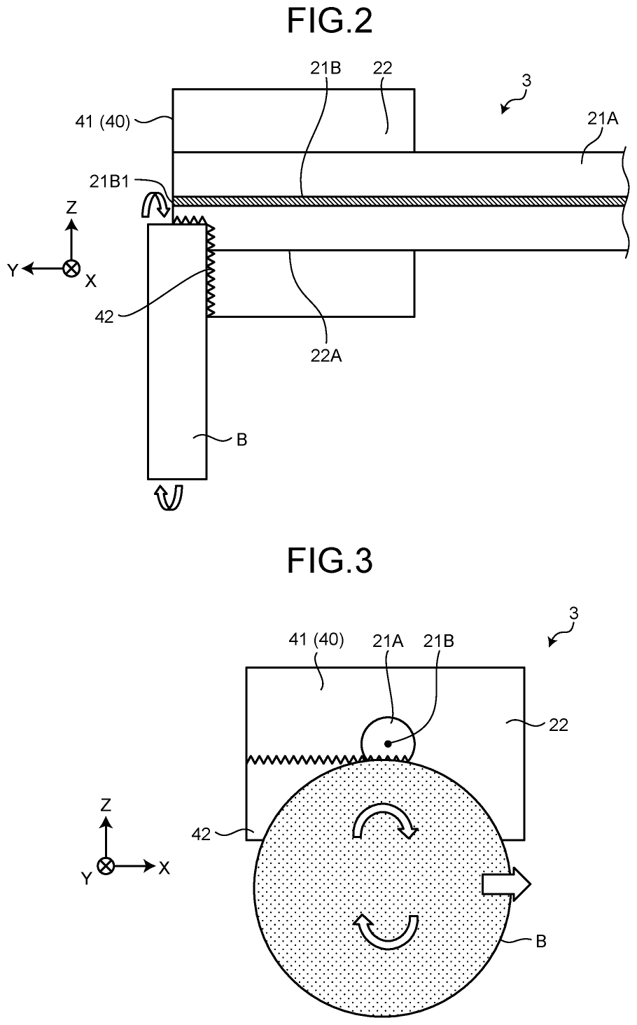

FIG. 2 is a schematic cross-sectional view illustrating an example of a lapping step of the optical fiber block 3, and FIG. 3 is an explanatory view of the lapping step of the optical fiber block 3 as viewed from the Y direction. The core end face 21B1 of the optical fiber 21 of the optical fiber block 3 cuts a part of the cladding 21A within a range not affecting the optical path. Specifically, the blade B is installed on an X-Z plane, and is moved in the X direction to perform cutting, thereby forming the fourth end face 42 on the third end face 41 which is the cut surface 40 of the optical fiber block 3. Then, the second step L2 is formed between the third end face 41 and the fourth end face 42. As a result, the cut surface 40 of the optical fiber block 3 can be easily provided with the second step L2 substantially equal to the first step L1, which is the distance between the first end face 31 including the end face 13A of the optical waveguide 13 of the lapped optical element 2 and the second end face 32.

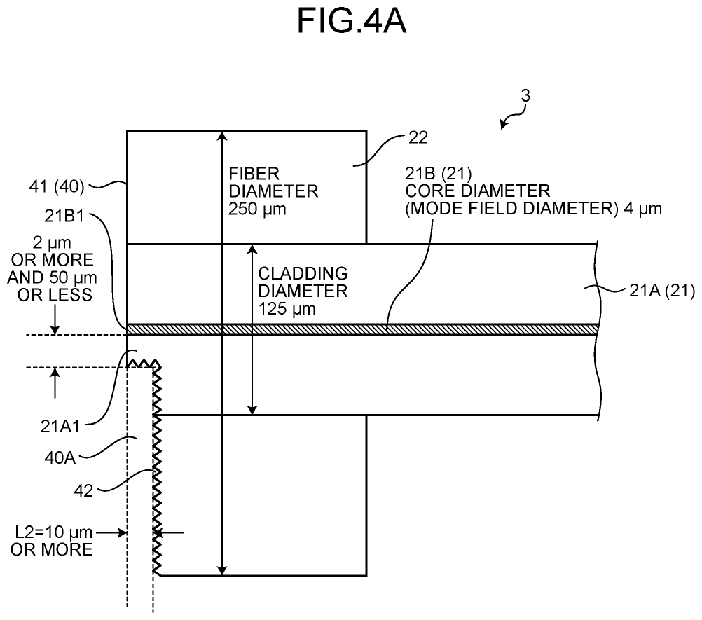

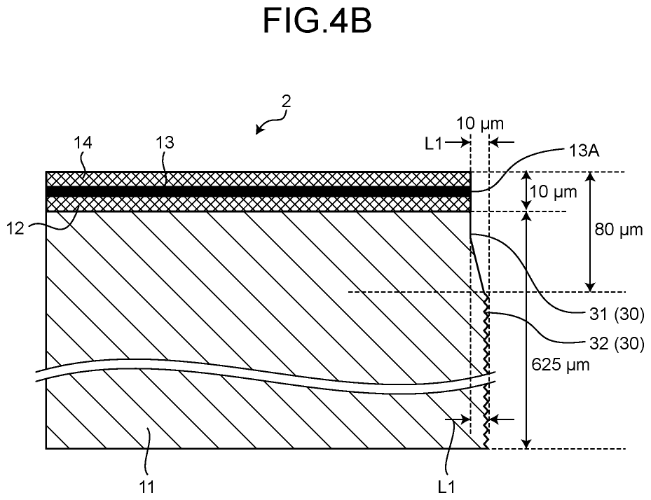

FIG. 4A is a schematic cross-sectional view illustrating an example of the optical fiber block 3 after the lapping step. The fiber diameter of the optical fiber block 3 is, for example, 250 μm, the cladding diameter of the optical fiber 21 is, for example, 125 μm, and the core diameter (mode field diameter) of the optical fiber 21 is, for example, 4 μm. The second step L2 between the third end face 41 and the fourth end face 42 is, for example, 10 μm or more. Further, the cladding 21A of the optical fiber 21 in the vicinity of the fourth end face 42 corresponds to a cladding remainder 21A1 between the core 21B and the fourth end face 42, and the dimension from the core 21B to a dent portion 40A of the fourth end face 42 is, for example, in the range of 2 μm to 50 μm.

FIG. 4B is a schematic cross-sectional view illustrating an example of the optical element 2 after the lapping step. The thickness of the Si substrate 11 is, for example, 625 μm. In the optical element 2, the second end face 32 to be the cut surface 30 is formed by dicing with the lapping blade B, and the first end face 31 is formed by optically polishing the vicinity of the end face 13A of the optical waveguide 13 in the cut surface 30. Specifically, the entire surface of the cut surface 30 of the optical element 2 is not lapped, but lapped to a depth of about 80 μm from the surface of the optical element 2 on the optical waveguide 13 side, and thereby, the cut surface to a depth of about 10 μm from the surface of the optical element 2 on the optical waveguide 13 side is optically polished. As a result, the first end face 31 including the end face 13A of the optical waveguide 13 becomes the optical surface. Then, the first step L1 is formed between the first end face 31 and the second end face 32. At this time, the first step L1 between the first end face 31 and the second end face 32 is, for example, about 10 μm.

Then, in the optical device 1, in a state where the second end face 32 and the fourth end face 42 are fixed so as to be in contact with each other, the first end face 31 and the third end face 41 are connected by butt coupling using the optical adhesive A. The end face 13A of the optical waveguide 13 in the optical element 2 and the core end face 21B1 of the optical fiber 21 in the optical fiber block 3 are optically coupled. Since the dent portion 40A of the cladding remainder 21A1 of the cut optical fiber 21 is filled with the optical adhesive A, it is possible to reduce the influence on the light refractive index due to partial cutting of the cladding 21A.

In the optical device 1 of first example, as illustrated in FIG. 4A, a second step L2 having a distance substantially equal to the first step L1 formed on the cut surface 30 of the lapped optical element 2 is provided on the cut surface 40 of the optical fiber block 3. Then, in a state where the fourth end face 42 of the optical fiber block 3 and the second end face 32 of the optical element 2 are brought into contact with each other, the optical device 1 optically couples the end face 13A of the optical waveguide 13 and the core end face 21B1 of the optical fiber 21 by butt-joint connection between the first end face 31 and the third end face 41. As a result, the optical coupling loss between the optical fiber 21 and the optical waveguide 13 is 0.74 dB, and the optical coupling loss is improved by 0.62 dB as compared with the optical device 100A of the first comparative example. In addition, in the configuration of the present example, the first end face 31 including the end face of the optical waveguide 13 of the optical element 2 is selectively optically polished using lapping, so that the lead time can be shortened.

In the optical fiber block 3, the blade B is placed on the X-Z plane and is moved in the X direction to perform cutting, thereby forming the fourth end face 42 on the third end face 41 which is the cut surface 40 of the optical fiber block 3. However, the present invention is not limited thereto, and can be appropriately changed. Therefore, the embodiment will be described below as a second example.

### (b) Second Example

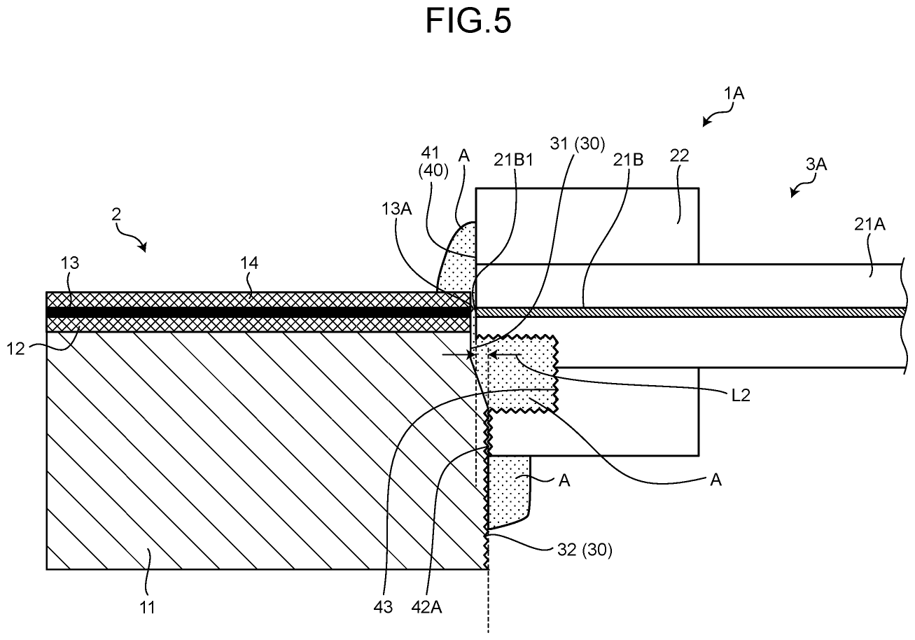

FIG. 5 is a schematic cross-sectional view illustrating an example of an optical device 1A according to a second example. Note that the same components as those of the optical device 1 of the first example are denoted by the same reference numerals, and the description of the overlapping components and operations will be omitted. An optical fiber block 3A has a third end face 41, a fourth end face 42A, and an opening 43 formed between the third end face 41 and the fourth end face 42A.

In the optical device 1A, in a state where the second end face 32 and the fourth end face 42A are fixed so as to be in contact with each other, the first end face 31 and the third end face 41 are connected by butt coupling using the optical adhesive A. Then, the end face 13A of the optical waveguide 13 in the optical element 2 and the core end face 21B1 of the optical fiber 21 in the optical fiber block 3A are optically coupled. The opening 43 is filled with the optical adhesive A.

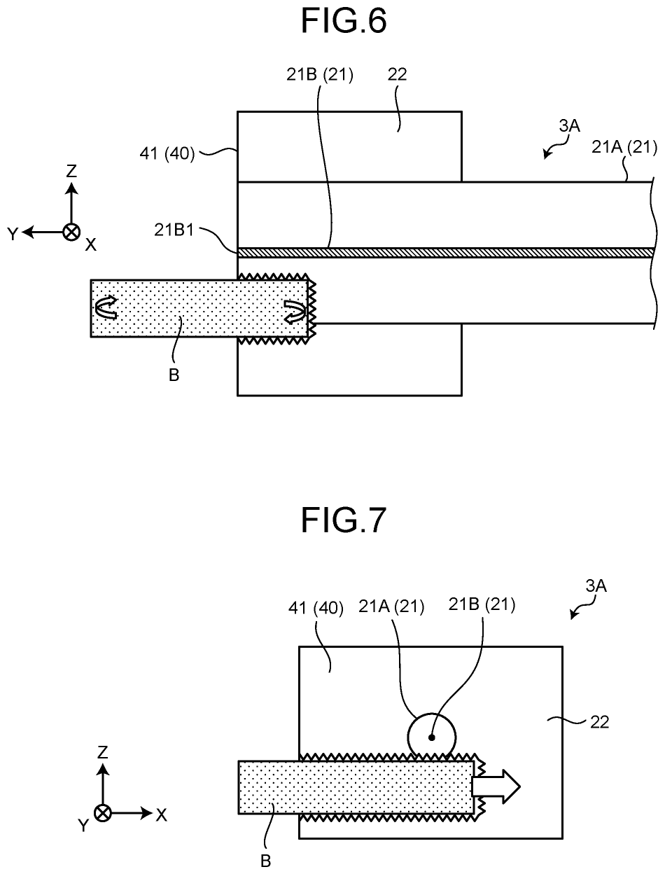

Next, a method for manufacturing the optical device 1A according to the second example will be described. The optical fiber block 3A forms the fourth end face 42A by two-stage cutting of a portion that does not affect the optical path of the optical fiber 21. FIG. 6 is a schematic cross-sectional view illustrating an example of a first lapping step of the optical fiber block 3A, and FIG. 7 is an explanatory view of the first lapping step of the optical fiber block 3A as viewed from the Y direction. In the first lapping step illustrated in FIGS. 6 and 7, the blade B is placed on the X-Y plane and performs cutting horizontally (in the X direction) with the optical path to form the opening 43 in the third end face 41 which is the cut surface 40.

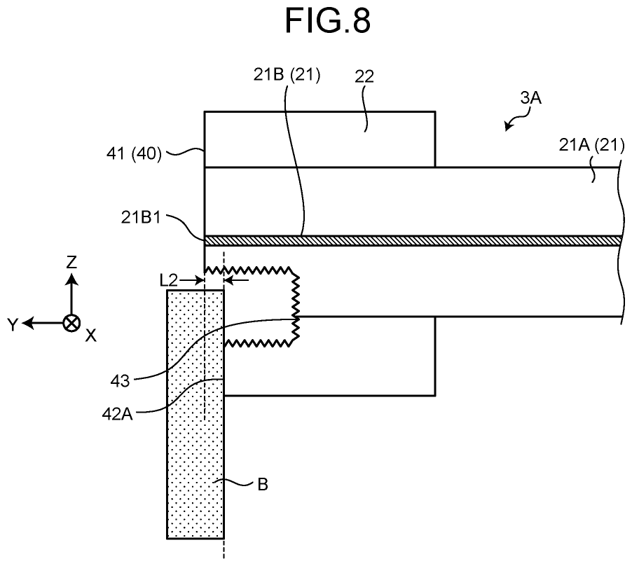

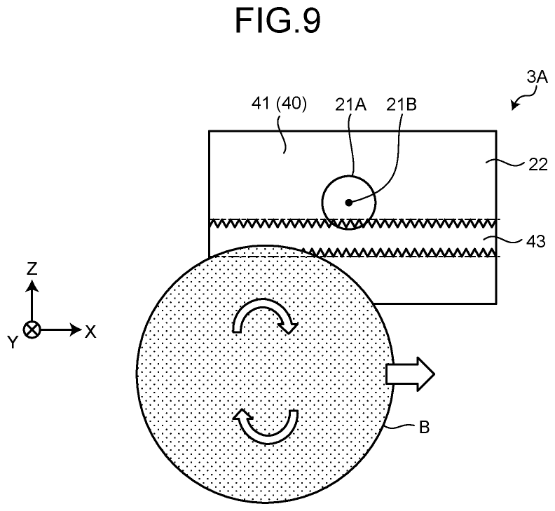

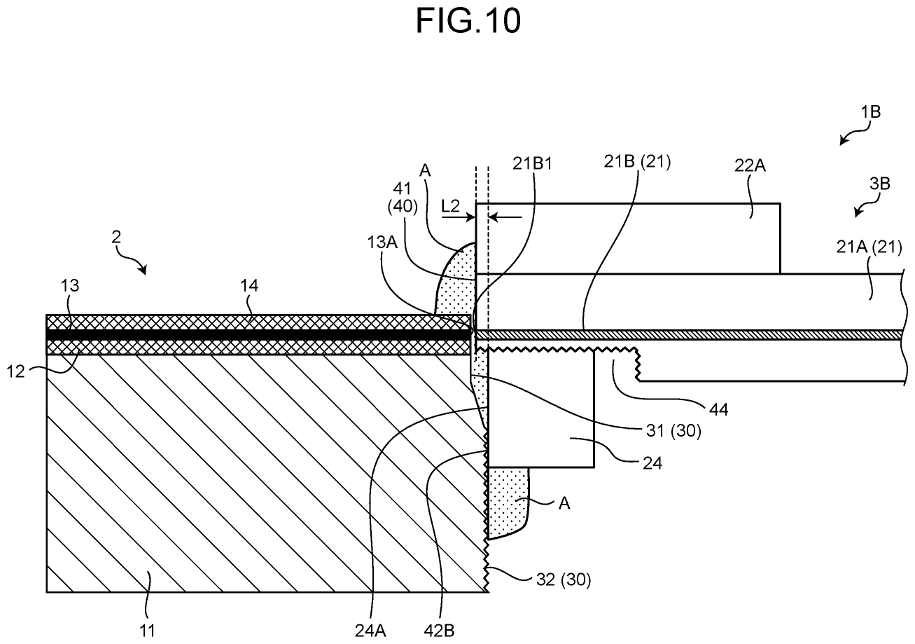

FIG. 8 is a schematic cross-sectional view illustrating an example of a second lapping step of the optical fiber block 3A, and FIG. 9 is an explanatory view of the second lapping step of the optical fiber block 3A as viewed from the Y direction. In the second lapping step illustrated in FIGS. 8 and 9, the blade B is installed on the X-Z plane, and is moved in the X direction to perform cutting, thereby forming the fourth end face 42A on the cut surface 40. As a result, the second step L2 substantially equal to the first step L1 of the optical element 2 lapped with higher accuracy can be provided on the cut surface 40 of the optical fiber block 3A.

In the optical device 1A of the second example, in a state where the second end face 32 and the fourth end face 42A are fixed so as to be in contact with each other, the first end face 31 and the third end face 41 are connected by butt coupling using the optical adhesive A. As a result, the end face 13A of the optical waveguide 13 in the optical element 2 and the core end face 21B1 of the optical fiber 21 in the optical fiber block 3A are optically coupled. In addition, since the opening 43 of the cladding 21A of the cut optical fiber 21 is embedded with the optical adhesive A, it is possible to reduce the influence on the light refractive index due to partial cutting of the cladding 21A.

Since the optical device 1A can shorten the distance between the core end face 21B1 of the optical fiber 21 and the end face 13A of the optical waveguide 13, the optical coupling loss between the optical waveguide 13 and the optical fiber 21 can also be suppressed to a minimum. In addition, cutting for forming the fourth end face 42A of the optical fiber block 3A can be easily performed in a short time.

### (c) Third Example

FIG. 10 is a schematic cross-sectional view illustrating an example of an optical device 1B according to a third example. Note that the same components as those of the optical device 1 of the first example are denoted by the same reference numerals, and the description of the overlapping components and operations will be omitted. An optical fiber block 3B illustrated in FIG. 10 includes an optical fiber 21, a first glass block 22A, and a separate second glass block 24 different from the first glass block 22A. The optical fiber 21 has an opening 44 formed by cutting the cladding 21A in the vicinity of the core end face 21B1. The second glass block 24 is fixed to the opening 44 of the optical fiber 21 with the optical adhesive A.

The optical fiber block 3B includes the third end face 41 and a fourth end face 42B. The third end face 41 is constituted by the core end face 21B1 of the optical fiber 21 and the end face of the first glass block 22A. The fourth end face 42B is formed of an end face 24A of the second glass block 24.

In the optical device 1B, in a state where the second end face 32 and the fourth end face 42B are fixed so as to be in contact with each other, the first end face 31 and the third end face 41 are connected by butt coupling using the optical adhesive A. The end face 13A of the optical waveguide 13 in the optical element 2 and the core end face 21B1 of the optical fiber 21 are optically coupled. The opening 44 is filled with the optical adhesive A.

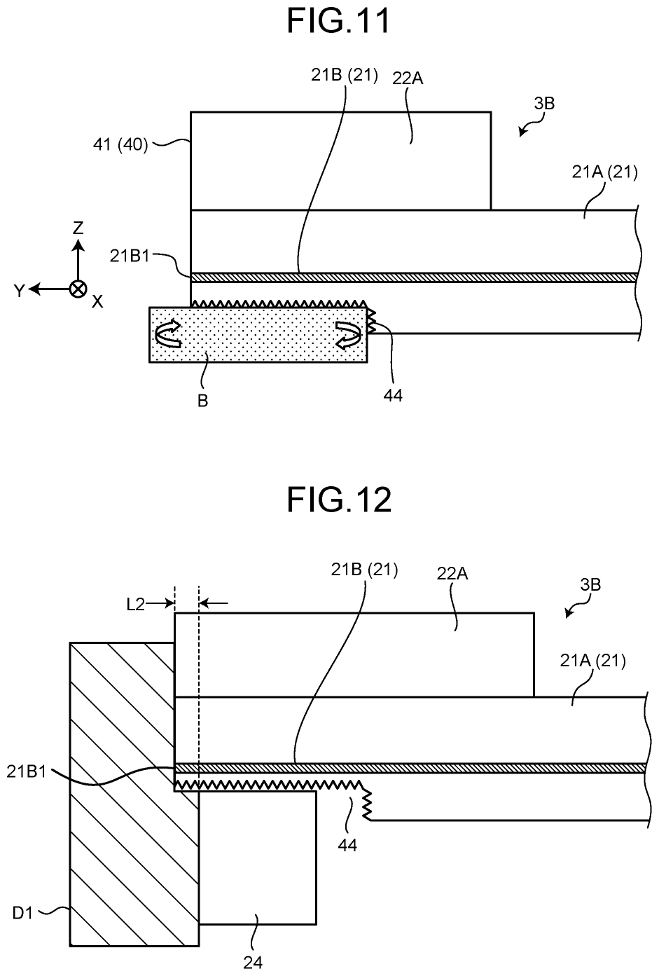

Next, a method for manufacturing the optical device 1B according to the third example will be described. FIG. 11 is a schematic cross-sectional view illustrating an example of the lapping step of the optical fiber block 3B. As illustrated in FIG. 11, the optical fiber block 3B forms the opening 44 by cutting a part of the cladding 21A of the optical fiber 21 horizontally with the optical path within a range not affecting the optical path of the optical fiber 21. The second glass block 24 is fixed to the optical fiber 21 in the opening 44 with the optical adhesive A such that a second step L2 substantially equal to the first step L1 of the optical element 2 is formed. FIG. 12 is a schematic cross-sectional view illustrating an example of a second glass block disposing step. As illustrated in FIG. 12, a jig D1 used for forming the second step L2 is prepared. In the second glass block disposing step, the second glass block 24 is disposed in the opening 44 in a state of being in contact with the third end face 41 of the first glass block 22A and in a state of having the jig D1 in contact with the fourth end face 42B of the second glass block 24 in the opening 44. Then, by disposing the second glass block 24 in the opening 44, the second glass block 24 is fixed to the optical fiber 21 in the opening 44. As a result, in the optical fiber block 3B, the second step L2 between the third end face 41 and the fourth end face 42B is formed.

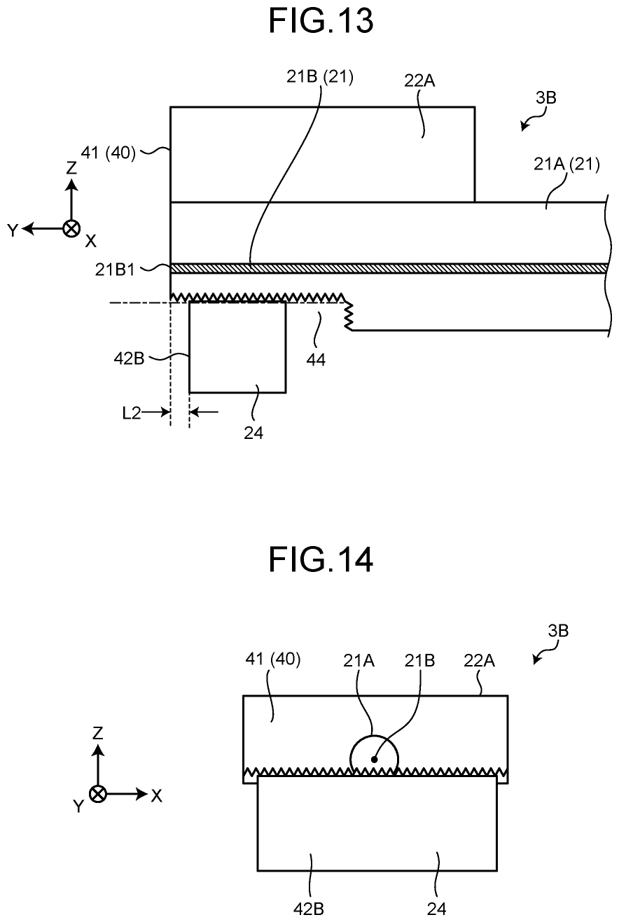

FIG. 13 is a schematic cross-sectional view illustrating an example of the optical fiber block 3B, and FIG. 14 is an explanatory view of the optical fiber block 3B as viewed from the Y direction. Then, in the optical device 1B, in a state where the second end face 32 and the fourth end face 42B are fixed so as to be in contact with each other, the first end face 31 and the third end face 41 are connected by butt coupling using the optical adhesive A. The end face 13A of the optical waveguide 13 in the optical element 2 and the core end face 21B1 of the optical fiber 21 are optically coupled. Furthermore, since the opening 44 of the cladding 21A of the cut optical fiber 21 is embedded with the optical adhesive A, it is possible to reduce the influence on the light refractive index due to partial cutting of the cladding 21A.

Note that, in the example, the case where cutting is performed using the lapping blade B has been exemplified, but the cutting is not limited to being performed with the blade, for example, cutting may be performed with a laser or a water flow pressure, and appropriate modification can be made.

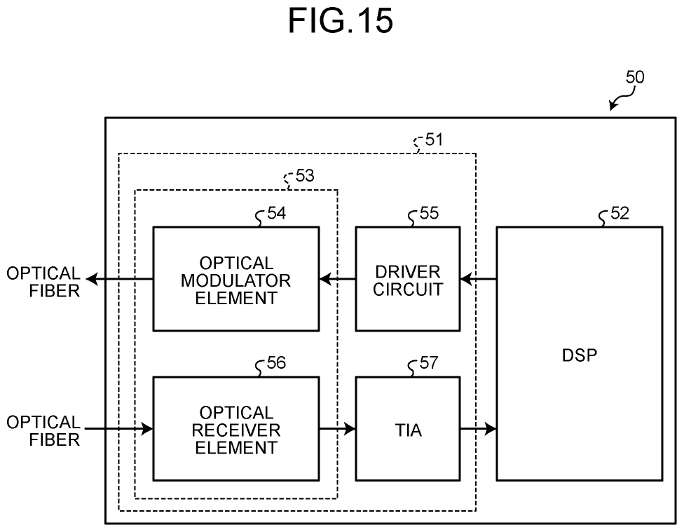

Next, an optical transceiver 50 employing the optical device 1 of the present example will be described. FIG. 15 is an explanatory view illustrating an example of an optical transceiver employing the optical device of the present example. The optical transceiver 50 illustrated in FIG. 15 includes an optical transmitter/receiver 51 and a digital signal processor (DSP) 52. The optical transmitter/receiver 51 includes an optical modulator element 54, a driver circuit 55, an optical receiver element 56, and a transimpedance amplifier (TIA) 57. DSP 52 controls the entire optical transmitter/receiver 51. The DSP 52 is an electrical component that executes digital signal processing for executing IQ modulation processing of a transmission signal and demodulation processing of a reception signal.

The DSP 52 executes, for example, processing such as encoding of transmission data, generates an electric signal including the transmission data, and outputs the generated electric signal to the driver circuit 55. The driver circuit 55 drives the optical modulator element 54 in accordance with the electrical signal from the DSP 52. The optical modulator element 54 incorporates an optical device 1 that connects an optical waveguide and an optical fiber in an optical modulator that optically modulates signal light.

The optical receiver element 56 electrically converts the signal light. The optical receiver element 56 incorporates the optical device 1 that connects an optical waveguide and an optical fiber in a photodetector that electrically converts signal light. TIA 57 amplifies the electrical signal after the electrical conversion, and outputs the amplified electrical signal to DSP 52. The DSP 52 performs processing such as decoding of the electrical signal acquired from the TIA 57 to obtain reception data.

Note that, for convenience of description, the case where the optical transceiver 50 incorporates a communication element 53 including the optical modulator element 54 and the optical receiver element 56 has been exemplified, but the present invention is also applicable to an optical transmission apparatus incorporating only the optical modulator element 54 and an optical reception apparatus incorporating only the optical receiver element 56.

In addition, each component of each unit illustrated in the drawings is not necessarily physically configured as illustrated in the drawings. That is, a specific form of distribution and integration of each unit is not limited to the illustrated form, and all or a part thereof can be functionally or physically distributed and integrated in an optional unit according to various loads, usage conditions, and the like.

Furthermore, all or any part of various processing functions performed in each device may be executed on a central processing unit (CPU) (or a micro computer such as a micro processing unit (MPU) or a micro controller unit (MCU)). In addition, it goes without saying that all or any part of the various processing functions may be executed on a program analyzed and executed by a CPU (or a micro computer such as an MPU or an MCU) or on hardware by wired logic.

According to one aspect of the optical device disclosed in the present application, optical coupling loss between the optical waveguide and the optical fiber can be suppressed.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
an optical element including an optical waveguide, a first end face on which an end face of the optical waveguide is disposed, and a second end face protruding from the first end face; and
an optical fiber block including an optical fiber, a third end face on which an end face of the optical fiber is disposed, and a fourth end face recessed from the third end face,
wherein the first end face and the third end face are connected by butt coupling to optically couple the end face of the optical waveguide and the end face of the optical fiber in a state where the second end face and the fourth end face are fixed to be in contact with each other.

2. The optical device according to claim 1, wherein the optical fiber block includes an opening disposed between the third end face and the fourth end face.

3. The optical device according to claim 1, wherein
the optical fiber block includes a first glass block and a second glass block different from the first glass block, and
the fourth end face includes an end face of the second glass block.

4. The optical device according to claim 1, wherein a first step between the first end face and the second end face is substantially equal to a second step between the third end face and the fourth end face.

5. An optical transmission apparatus comprising:
an optical modulator element including an optical waveguide, a first end face on which an end face of the optical waveguide is disposed, and a second end face protruding from the first end face; and
an optical fiber block including an optical fiber, a third end face on which an end face of the optical fiber is disposed, and a fourth end face recessed from the third end face,
wherein the first end face and the third end face are connected by butt coupling to optically couple the end face of the optical waveguide and the end face of the optical fiber in a state where the second end face and the fourth end face are fixed to be in contact with each other.

6. An optical reception apparatus comprising:
an optical receiver element including an optical waveguide, a first end face on which an end face of the optical waveguide is disposed, and a second end face protruding from the first end face; and
an optical fiber block including an optical fiber, a third end face on which an end face of the optical fiber is disposed, and a fourth end face recessed from the third end face,
wherein the first end face and the third end face are connected by butt coupling to optically couple the end face of the optical waveguide and the end face of the optical fiber in a state where the second end face and the fourth end face are fixed to be in contact with each other.
